(19) United States
(12) Patent Application Publication
(10) Pub. No.: US 2013/0309924 A1
(43) Pub. Date: Nov. 21, 2013

(54) REINFORCED PULTRUDED POLYURETHANE AND PRODUCTION THEREOF

(71) Applicants: Dirk Wegener, Monheim (DE); Stefan Lindner, Koln (DE); Stephan Schleiermacher, Pulheim (DE)

(72) Inventors: Dirk Wegener, Monheim (DE); Stefan Lindner, Koln (DE); Stephan Schleiermacher, Pulheim (DE)

(73) Assignee: Bayer Intellectual Property Gmbh, Monheim (DE)

(21) Appl. No.: 13/981,969

(22) PCT Filed: Jan. 23, 2012
(86) PCT No.: PCT/EP12/50962

§ 371 Date: Jul. 26, 2013

(30) Foreign Application Priority Data
Jan. 28, 2011 (DE) 10 2011 003 294.0

(51) Int. Cl. C08L 75/08

(52) U.S. Cl. CPC C08L 75/08
USPC 442/59; 523/400; 428/375; 264/164

(57) ABSTRACT

The invention relates to reinforced pultruded polyurethane and to a method for the production thereof by pultrusion.

The present invention relates to reinforced pultruded polyurethane and to a process for production thereof via pultrusion.

WO 01/92364 A1 describes a resin composition made of polyisocyanate, polyol and from 5 to 20% of bisphenol A epoxy resin. The polyisocyanate can involve an aromatic polyisocyanate, and the polyol component is composed of a mixture of polyester polyol and polyether polyol. MDI is mentioned as polyisocyanate. The polyether polyol used can comprise one or more organic polyhydroxy compounds with an average mass of from 70 to 400. The addition of fibers such as glass fibers for applications such as pultrusion is likewise described. A wide pot life range is mentioned, without provision of any information as to how specific pot lives can be achieved. Equally, no information is provided in relation to the pot lives or gel times of individual compositions. It is obvious to the person skilled in the art that the lower range within the range mentioned, from 5 minutes to 3 hours, is not suitable for pultrusion, since adequate saturation of the reinforcing fibers is not ensured. Information relating to final properties, such as an adequately high glass transition temperature, is provided only in general terms. It is mentioned that a high crosslinking density has to be obtained in order to achieve a high glass transition temperature. It is obvious to the person skilled in the art that said high crosslinking density gives a pot life or gel time in the lower, unsuitable range.

US 20080090921 describes a resin composition which comprises at least one DMC-catalyzed polyether and one isocyanate. No information is given in relation to pot lives and gel times, or glass transition temperatures of individual compositions.

It was an object of the present invention to provide pultruded polyurethanes which exhibit good processing conditions, for example long available processing time, together with good product properties, for example high glass transition temperatures and high moduli, and also a process for producing same.

Surprisingly, the object was achieved via the pultruded polyurethanes of the invention.

The invention provides reinforced pultruded polyurethanes obtainable according to the pultrusion method via reaction of
A) a mixture of not homogeneously miscible components a) and b) with
   a) one or more polyether polyols with an OH number of from 15 to 50 based on propylene oxide and
   b) a mixture of one or more polyether polyols with an OH number from 150 to 600 and one or more chain extenders and/or crosslinking agents with an OH number of from 700 to 1827, and
B) one or more epoxides with
C) organic polyisocyanates from the group consisting of butylene 1,4-diisocyanate, pentane 1,5-diisocyanate, hexamethylene 1,6-diisocyanate (HDI), isophorone diisocyanate (IPDI), 2,2,4- and/or 2,4,4-trimethylhexamethylene diisocyanate, the isomers of bis(isocyanatocyclohexyl)methane or a mixture of these with any desired isomer content, cyclohexylene 1,4-diisocyanate, phenylene 1,4-diisocyanate, tolylene 2,4- and/or 2,6-diisocyanate (TDI), naphthylene 1,5-diisocyanate, diphenylmethane 2,2′- and/or 2,4′- and/or 4,4′-diisocyanate (MDI) or higher homologs of MDI (polymeric MDI), 1,3- and/or 1,4-bis(2-isocyanatoprop-2-yl)benzene (TMXDI), 1,3-bis(isocyanatomethyl)benzene (XDI), and also alkyl 2,6-diisocyanatohexanoate (lysine diisocyanate) having C₁-C₆-alkyl groups, or a mixture thereof, and
optionally a proportion of modified diisocyanates having uretdione, isocyanurate, urethane, carbodiimide, uretonimine, allophanate, biuret, amide, iminooxadiazinedione and/or oxadiazinetrione structure or else unmodified polyisocyanates having more than 2 NCO groups per molecule
in the presence of
D) optionally catalysts
E) mold-release agents
F) optionally inhibitors
G) optionally other additives and/or auxiliaries
H) optionally fillers
I) continuous-filament fibers, fiber mats, and/or textile fabrics as reinforcing materials.

The invention further provides a process for producing the reinforced pultruded polyurethanes of the invention by means of pultrusion technology, characterized in that
(i) components a) and b) are mixed with one another,
(ii) components B), D), E), F), G) and H) are admixed with the mixture from (i),
(iii) isocyanate component C) is added in a mixing chamber to the mixture from (ii),
(iv) the reaction mixture from (iii) is passed into an injection box,
(v) at the same time as step (iv), the reinforcing materials I) are passed through the injection box and are passed, together with the reaction mixture (iii) present in the injection box, through a chamber in which curing takes place,
(vi) the composite made of reaction mixture and of reinforcing materials is cured in the chamber,
(vii) the cured composite from (vi) is drawn out of the chamber by means of tension mechanisms, and
(viii) the cured composite is cut to the desired length.

The mixture of the polyols a) and b) is inhomogeneous, i.e. has at least two phases.

The mixture of the not homogeneously miscible components a) and b) preferably comprises the following proportions, where the sum of the proportions by weight is 100:

a) from ≧10% by weight to ≦30% by weight of one or more polyether polyols with an OH number of from 15 to 50 based on propylene oxide

b) from ≧45% by weight to ≦65% by weight of one or more polyether polyols with an OH number of from 150 to 600 and from ≧15% by weight to ≦35% by weight of one or more chain extenders and/or crosslinking agents with an OH number of from 700 to 1827.

The curing process in the chamber is preferably brought about via elevated temperature. In the preferred method of heating, the chamber preferably has a plurality of heating zones. The chamber can if necessary be utilized simultaneously for a shaping process.

Epoxides that can be used are aliphatic, cycloaliphatic or aromatic epoxides of low viscosity, or else a mixture of these. The epoxides can be produced by reaction of, for example, epichlorohydrin with alcohols. Examples of alcohols that can be used are bisphenol A, bisphenol F, bisphenol S, cyclohexanedimethanol, phenol-formaldehyde resins, cresol-formaldehyde novolaks, butanediol, hexanediol, trimethylolpropane, and polyether polyols. It is also possible to use glycidyl esters, for example phthalic acid, isophthalic acid or terephthalic acid, or else a mixture of these. Epoxides can also be produced via epoxidizing organic compounds comprising double bonds, for example, via epoxidation of fatty oils, such as soya oil, to give epoxidized soya oil. Other epoxides that can be used are monofunctional epoxides. These can be produced via the reaction of, for example, epichlorohydrin with monoalcohols, for example monoglycidyl ethers of alcohols having from 4 to 18 carbon atoms, cresol, or p-tert-butylphenol. Other epoxides that can be used are described by way of example in “Handbook of Epoxy resins” by Henry Lee and Kris Neville, McGraw-Hill Book Company, 1967. The epoxide equivalent can be determined in accordance with ASTM D1652.

Examples of suitable polyisocyanates are butylene 1,4-diisocyanate, pentane 1,5-diisocyanate, hexamethylene 1,6-diisocyanate (HDI), isophorone diisocyanate (IPDI), 2,2,4- and/or 2,4,4-trimethylhexamethylene diisocyanate, the isomers of bis(isocyanatocyclohexyl)methane or a mixture of these with any desired isomer content, cyclohexylene 1,4-diisocyanate, phenylene 1,4-diisocyanate, tolylene 2,4- and/or 2,6-diisocyanate (TDI), naphthylene 1,5-diisocyanate, diphenylmethane 2,2′- and/or 2,4′- and/or 4,4′-diisocyanate (MDI) or higher homologs of MDI (polymeric MDI), 1,3- and/or 1,4-bis(2-isocyanatoprop-2-yl)benzene (TMXDI), 1,3-bis(isocyanatomethyl)benzene (XDI), and also alkyl 2,6-diisocyanatohexanoate (lysine diisocyanate) having C₁-C₆-alkyl groups. Particular preference is given to a mixture of MDI and polymeric MDI (p MDI).

A proportion of modified diisocyanates having uretdione, isocyanurate, urethane, carbodiimide, uretonimine, allophanate, biuret, amide, iminooxadiazinedione and/or oxadiazinetrione structure or else unmodified polyisocyanate having more than 2 NCO groups per molecule, an example being 4-isocyanatomethyloctane 1,8-diisocyanate (nonane triisocyanate) or triphenylmethane 4,4′,4″-triisocyanate, can also be used alongside the polyisocyanates mentioned previously.

The numeric ratio of the number of NCO groups in the isocyanate component used to the number of groups reactive toward isocyanates (also called the index) is preferably from ≧70:100 to ≦150:100, particularly from ≧90:100 to ≦130:100.

The gelling reaction, which per se proceeds slowly, can optionally be accelerated via addition of catalysts. It is possible here to use catalysts known per se which accelerate the reaction between hydroxy and isocyanate groups. In particular, it is possible to use tertiary amines of the type known per se, e.g. triethylamine, tributylamine, N-methylmorpholine, N-ethylmorpholine, N-cocomorpholine, N,N,N′,N′-tetramethylethylenediamine, 1,4-diazabicyclo[2.2.2]octane, N-methyl-N′-dimethylaminoethylpiperazine, N,N-dimethylcyclohexylamine, N,N,N′,N′-tetramethyl-1,3-butanediamine, N,N-dimethylimidazole-β-phenylethylamine, 1,2-dimethylimidazole, or 2-methylimidazole. Organometallic catalysts, in particular organobismuth catalysts, e.g. bismuth(III) neodecanoate or organotin catalysts, e.g. tin(II) salts of carboxylic acids, e.g., tin(II) acetate, tin(II) octoate, tin(II) ethylhexoate and tin(II) laurate and the dialkyltin salts of carboxylic acids, e.g. dibutyltin diacetate, dibutyltin dilaurate, dibutyltin maleate, dibutyltin sulfide or dioctyltin diacetate, can be used alone or in combination with the tertiary amines. It is preferable to use from 0 to 5% by weight, in particular from 0.3 to 2.0% by weight, of catalyst or catalyst combination, based on the composition of the gel. Other catalysts, and also details concerning the mode of action of the catalysts, are described in Kunststoff-Handbuch [Plastics Handbook], vol. VII “Polyurethane”, 3rd edition, Carl Hanser Verlag, Munich/Vienna, 1993, on pages 104-110.

Fillers optionally to be used concomitantly can be either inorganic or organic fillers. Examples that may be mentioned of inorganic fillers are: silicatic minerals, for example phyllosilicates, metal oxides, such as iron oxides, in particular pyrogenically produced metal oxides, such as Aerosils (as described EP-B-1 125 975), metal salts, such as barite, inorganic pigments such as cadmium sulfide, zinc sulfide, and also glass, and hollow or solid glass microbeads, etc. Natural and synthetic fibrous minerals can be used, for example wollastonite and glass fibers of varying length, which optionally can have been sized. Examples that may be mentioned of organic fillers are: crystalline paraffins or fats (“Phase-change material”) (as described in EP-B-1 277 801), powder based on polystyrene, from polyvinyl chloride, from urea-formaldehyde compositions and/or polyhydrazodicarbonamides (e.g. those obtained from hydrazine and from toluylene diisocyanate). By way of example here, urea-formaldehyde resins or polyhydrazodicarbonamides can have been produced directly in one of the polyols to be used for the inventive production of gels. It is also possible to add hollow microbeads of organic origin (as described in EP-B-1 142 943) or cork (as described in DE 100 24 087). The organic or inorganic fillers can be used individually or in the form of a mixture. If fillers are added to the reaction mixture, the amounts added thereof are from 0 to 50% by weight, preferably from 0 to 30% by weight, based on the total weight of the gel.

Mold-released agents that can be used are by way of example the mold-release agents known from pultrusion processes.

Among the auxiliaries and additives that can optionally be used concomitantly are by way of example colorant agents, water-binding substances, flame retardants, plasticizers and/or monohydric alcohols.

The gels of the invention can comprise as colorant agents, by way of example, organic and/or inorganic dyes and/or color pigments which are known per se for the coloring of polyurethanes, examples being iron oxide pigments and/or chromium oxide pigments and phthalocyanine-based and/or monoazo-based pigments.

Suitable water-binding substances are not only compounds having high reactivity toward water, e.g. tris(chloroethyl) orthoformate, but also water-binding fillers, e.g. alkaline earth metal oxides, zeolites, aluminum oxides and silicates. Examples of suitable synthetic zeolites are available commercially as Baylith®.

Examples of suitable flame retardants optionally to be used concomitantly are tricresyl phosphate, tris-2-chloroethyl phosphate, tris-chloropropyl phosphate and tris-2,3-dibromopropyl phosphate. Compounds that can also be used, other than the abovementioned halogen-substituted phosphates are inorganic flame retardants such as aluminum oxide hydrate, ammonium polyphosphate, calcium sulfate, sodium polymetaphosphate or amine phosphates, e.g. melamine phosphates.

Other additives optionally to be used concomitantly are monohydric alcohols, such as butanol, 2-ethylhexanol, octanol, dodecanol or cyclohexanol, where these can optionally be used concomitantly in order to bring about desired chain termination.

Examples of continuous-filament fibers or of fiber mats that can be used are glass fibers, carbon fibers, polyester fibers, aramid fibers, polyethylene fibers, basalt fibers, steel fibers, and natural fibers and fiber mats produced therefrom. A high proportion of fiber in the pultruded polyurethane is advantageous for the mechanical properties of the product. The proportion of fiber is preferably from 60 to 90% by weight, particularly preferably from 75 to 85% by weight.

The reactive polyurethane mixtures used have very good suitability for the production of pultruded materials.

The examples below will be used for further explanation of the invention.

### EXAMPLES

The matrix properties described below were determined on sheets of matrix without reinforcing materials I). The reactive polyurethane mixtures used can be processed in commercially available pultrusion plants.

Production of Test Sheets:

The polyol formulation (mixture of components a) and b), and also components B) to D) and H)) was degassed for 45 minutes and then mixed with degassed isocyanate C). The mixture was stirred for a few minutes at a pressure of about 10 mbar. The mixture was then poured into a sheet mold of thickness 4 mm. The specimen was then heat-conditioned at 160° C. for two hours.

The sheets were used to produce test specimens which were characterized by the DIN EN ISO 6721-B: 1996-12 torsion pendulum method. The properties determined here were: torsion storage modulus G′ at 20° C. and glass transition temperature Tg as maximum of the loss factor tan δ.

Gel time was determined by using a gel timer.

Starting Components:

Component a): Linear polypropylene oxide polyol, hydroxy number 28 mg KOH/g.

Component b1): Trihydric polypropylene oxide polyol using glycerol as starter, hydroxy number 235 mg KOH/g.

Component b2): Trihydric polypropylene oxide polyol using glycerol as starter, hydroxy number 450 mg KOH/g.

Component b3): Trihydric polypropylene oxide polyol using glycerol as starter, hydroxy number 1050 mg KOH/g.

Component G): Zeolite-based desiccant. Component E): Techlube 550 HB release agent from Technick Products.

Component D): Fomrez UL29: catalyst from Momentive.

Component B1): Eurepox 710: bisphenol A epichlorohydrin resin with average molar mass ≦700 g/mol; epoxide equivalent weight from 183 to 189 g/eq; viscosity at 25° C.: from 10 000 to 12 000 mPas.

Component B2): Araldite DY-T: triglycidyl ether of trimethylol propane, product from Huntsman; epoxide equivalent weight from 122 to 128 g/eq, viscosity at 25° C.: from 100 to 300 mPas.

Component B3): Araldite DY-D: diglycidyl ether of butanediol, product from Huntsman; epoxide equivalent weight from 118 to 125 g/eq, viscosity at 25° C.: from 15 to 25 mPas.

Component B4): Araldite DY-K: monoglycidyl ether of cresol, product from Huntsman; epoxide equivalent weight from 175 to 189 g/eq, viscosity at 25° C.: from 6 to 12 mPas.

Component C): Polymeric MDI having 31.4% by weight NCO content.

TABLE 1

| | Inventive | Inventive | Inventive | Inventive | Comparative | Comparative | Comparative | Comparative | Comparative |
|---|---|---|---|---|---|---|---|---|---|
| Composition of | Example 1 | example 2 | example 3 | example 4 | example 5 | example 6 | example 7 | example 8 | example 9 |
| Component a) | 25.21 | 25.21 | 25.21 | 25.21 | 28.02 | 143.72 | 133.44 | 142.02 | 130.84 |
| Component b1) | 37.83 | 37.83 | 37.83 | 37.83 | 42.05 | 143.72 | 133.44 | | |
| Component b2) | 31.55 | 31.55 | 31.55 | 31.55 | 35.01 | | | 142.02 | 130.84 |
| Component b3) | 31.51 | 31.51 | 31.51 | 31.51 | 35.03 | | | | |
| Component G) | 2.59 | 2.59 | 2.59 | 2.59 | 2.88 | 3.45 | 3.74 | 4.26 | 4.19 |
| Component E) | 6.04 | 6.04 | 6.04 | 6.04 | 6.05 | 7.76 | 8.01 | 10.23 | 9.16 |
| Component D) | 0.87 | 0.87 | 0.87 | 0.87 | 0.96 | 1.34 | 1.36 | 1.48 | 1.41 |
| Component B1) | 14.40 | | | | | | 20.02 | | 23.55 |
| Component B2) | | 14.40 | | | | | | | |
| Component B3) | | | 14.40 | | | | | | |
| Component B4) | | | | 14.40 | | | | | |
| Component C) | 169.36 | 178.64 | 192.84 | 168.59 | 173.99 | 104.60 | 114.87 | 189.02 | 194.52 |
| Torsion storage | 970.6 | 955.9 | 940.8 | 994.5 | 904.1 | 18.6 | 161.1 | 369.9 | 442.3 |
| modulus at G′ at | | | | | | | | | |
| 20° C. [MPa] | | | | | | | | | |
| Glass transition | 139.9 | 150.0 | 149.4 | 134.7 | 129.9 | 25.1 | 50.1 | 114.6 | 129.7 |
| temperature | | | | | | | | | |
| Tg [° C.] | | | | | | | | | |
| Gel time [min] | 36 | 20 | 25 | 26 | 31 | >210 | 280 | 85 | 98 |
| | | Comparative | Comparative | Comparative | Comparative | Comparative | Comparative | Comparative | Comparative |
| | | example | example | example | example | example | example | example | example |
| | Composition of | 10 | 11 | 12 | 13 | 14 | 15 | 16 | 17 |
| | Component a) | 93.08 | 82.67 | | | | | | |
| | Component b1) | | | 94.14 | 85.73 | 78.31 | 68.66 | | |
| | Component b2) | | | 94.14 | 85.73 | | | 73.23 | 64.36 |
| | Component b3) | 93.08 | 82.67 | | | 78.31 | 68.66 | 73.23 | 64.36 |
| | Component G) | 4.10 | 3.97 | 3.39 | 3.43 | 3.76 | 3.84 | 4.10 | 3.86 |
| | Component E) | 8.38 | 7.94 | 7.15 | 6.86 | 8.46 | 7.83 | 8.35 | 7.72 |
| | Component D) | 1.38 | 1.26 | 1.17 | 1.10 | 1.16 | 1.10 | 1.08 | 1.03 |
| | Component B1) | | 21.49 | | 17.15 | | 19.91 | | 18.66 |
| | Component B2) | | | | | | | | |
| | Component B3) | | | | | | | | |
| | Component B4) | | | | | | | | |
| | Component C) | 276.41 | 264.43 | 177.41 | 176.63 | 276.4 | 259.83 | 302.26 | 282.04 |
| | Torsion storage | 635.3 | 680.4 | 934.5 | 1053.0 | 1060.2 | 1146.3 | 1075.1 | 1195.5 |
| | modulus at G′ at | | | | | | | | |
| | 20° C. [MPa] | | | | | | | | |
| | Glass transition | 169.8 | 194.5 | 89.9 | 89.6 | 149.8 | 169.9 | 164.6 | 179.9 |
| | temperature | | | | | | | | |
| | Tg [° C.] | | | | | | | | |
| | Gel time [min] | 12 | 19 | 50 | 62 | 13 | 16 | 14 | 16 |

As can be seen in Table 1, the polyurethane moldings of the invention in inventive examples 1 to 4 exhibit good mechanical properties (high torsion storage modulus G′ and high glass transition temperature) together with long available processing time (long gel time), whereas in comparative examples 5 to 17 either torsion storage modulus G′ is too low or glass transition temperature is too low or gel time is too short.

1. Reinforced pultruded polyurethane obtainable via reacting
A) a mixture of not homogeneously miscible components a) and b) with
a) one or more polyether polyols with an OH number of from 15 to 50 based on propylene oxide and
b) a mixture of one or more polyether polyols with an OH number from 150 to 600 and one or more chain extenders and/or crosslinking agents with an OH number of from 700 to 1827, and
B) one or more epoxides with
C) organic polyisocyanates from the group consisting of butylene 1,4-diisocyanate, pentane 1,5-diisocyanate, hexamethylene 1,6-diisocyanate (HDI), isophorone diisocyanate (IPDI), 2,2,4- and/or 2,4,4-trimethylhexamethylene diisocyanate, the isomers of bis(isocyanatocyclohexyl)methane or a mixture of these with any desired isomer content, cyclohexylene 1,4-diisocyanate, phenylene 1,4-diisocyanate, toluylene 2,4- and/or 2,6-diisocyanate (TDI), naphthylene 1,5-diisocyanate, diphenylmethane 2,2′- and/or 2,4′- and/or 4,4′-diisocyanate (MDI) or higher homologs of MDI (polymeric MDI), 1,3- and/or 1,4-bis(2-isocyanatoprop-2-yl)benzene (TMXDI), 1,3-bis(isocyanatomethyl)benzene (XDI), and also alkyl 2,6-diisocyanatohexanoate (lysine diisocyanate) having C₁-C₆-alkyl groups, or a mixture thereof, and
optionally a proportion of modified diisocyanates having uretdione, isocyanurate, urethane, carbodiimide, uretonimine, allophanate, biuret, amide, iminooxadiazinedione and/or oxadiazinetrione structure or else unmodified polyisocyanate having more than 2 NCO groups per molecule
in the presence of
D) optionally a catalyst,
E) mold-release an agent,
F) optionally an inhibitor,
G) optionally other additives and/or auxiliaries,
H) optionally a filler or
I) a continuous-filament fiber, a fiber mat, and/or textile fabric as a reinforcing material.

2. The reinforced pultruded polyurethane as claimed in claim 1, where the mixture of the not homogenously miscible components a) and b) comprises the following proportions, where the sum of the proportions by weight is 100:
a) from ≧10% by weight to ≦30% by weight of one or more polyether polyols with an OH number of from 15 to 50 based on propylene oxide
b) from ≧45% by weight to ≦65% by weight of one or more polyether polyols with an OH number of from 150 to 600 and from ≧15% by weight to ≦35% by weight of one or more chain extenders and/or crosslinking agents with an OH number of from 700 to 1827.

3. A process for producing the reinforced pultruded polyurethane as claimed in claim 1 by means of pultrusion technology, wherein
(i) components a) and b) are mixed with one another,
(ii) components B), D), E), F), G) and H) are admixed with the mixture from (i),
(iii) isocyanate component C) is added in a mixing chamber to the mixture from (ii),
(iv) the reaction mixture from (iii) is passed into an injection box,
(v) at the same time as step (iv), the reinforcing materials I) are passed through the injection box and are passed, together with the reaction mixture (iii) present in the injection box, through a chamber in which curing takes place,
(vi) the composite made of reaction mixture and of reinforcing materials is cured in the chamber,
(vii) the cured composite from (vi) is drawn out of the chamber by means of tension mechanisms, and
(viii) the cured composite is cut to the desired length.

4. (canceled)

5. A process for producing pultruded materials which comprises a pultrusion process which utilizes the reinforced pultruded polyurethane as claimed in claim 1.

6. The reinforced pultruded polyurethane as claimed in claim 1, wherein the catalyst is present.

7. The reinforced pultruded polyurethane as claimed in claim 1, wherein the catalyst is present in an amount from 0.3 to 2% by weight.

8. The reinforced pultruded polyurethane as claimed in claim 1, wherein the mold release agent is present.

9. The reinforced pultruded polyurethane as claimed in claim 1, wherein component G is present.

10. The reinforced pultruded polyurethane as claimed in claim 7, wherein the mold release agent is present.

11. The reinforced pultruded polyurethane as claimed in claim 11, wherein component G is present.
